(19) United States
(12) Patent Application Publication
(10) Pub. No.: US 2026/0105098 A1
(43) Pub. Date: Apr. 16, 2026

(54) NATURAL LANGUAGE IMAGE SEARCHING METHOD AND IMAGE SEARCHING SYSTEM

(71) Applicant: VIVOTEK INC., New Taipei City (TW)

(72) Inventor: Jen-Chih Wu, New Taipei City (TW)

(73) Assignee: VIVOTEK INC., New Taipei City (TW)

(21) Appl. No.: 19/347,694

(22) Filed: Oct. 1, 2025

(30) Foreign Application Priority Data
Oct. 16, 2024 (TW) 113139285

(51) Int. Cl. G06F 16/53; G06F 16/56

(52) U.S. Cl. CPC G06F 16/53; G06F 16/56

(57) ABSTRACT

A natural language image searching method is applied to an image searching system including an image analysis unit, a data management unit and an instruction input unit. The natural language image searching method includes an image feature vector encoder of the image analysis unit receiving a detection image and generating an image feature vector, the image analysis unit transmitting the detection image, the image feature vector, and a time stamp associated with the detection image to the data management unit, a text encoder of the instruction input unit generating and transmitting a text feature vector to the data management unit in accordance with a query statement, and the data management unit determining whether the query statement generated by the instruction input unit via natural language conforms to the detection image in accordance with a comparison result between the text feature vector and the image feature vector.

### BACKGROUND OF THE INVENTION

### 1. FIELD OF THE INVENTION

The present invention relates to an image searching method and an image searching system, and more particularly, to a natural language image searching method and a related image searching system.

### 2. DESCRIPTION OF THE PRIOR ART

Conventional image search technology has to set a known search target and attribute, such as the pedestrian or the vehicle, and then performs image search to identify images that only contain the pedestrian or the vehicle from the image sequence (or the video data) based on the known search target. The images without the pedestrian or the vehicle (e.g., non-known search targets) do not appear in the image search result. Therefore, when using the conventional image search technology, the user must set the search criteria precisely for the target search. If the user is unfamiliar with the conventional image search technology and fails to set the suitable search criteria, or even if the user is familiar with the conventional image search technology but fails to set the suitable and accurate search criteria due to personal influence, the conventional image search technology is unable to identify the images that the user truly needs from the massive image sequence (or the video data), potentially missing some crucial images. In another situation, if the user cannot know the image content in advance, that is, cannot set the known search target and attribute, the image search result is limited, and correspondingly, the images that may meet the user's needs are missed. Design of an image search method that does not require precise search criteria and uses natural language for feature search so that the user can simply and conveniently set the image retrieval condition by colloquial language to widely and quickly search the correct target image is an important issue in the related surveillance industry.

### SUMMARY OF THE INVENTION

The present invention provides a natural language image searching method and a related image searching system for solving above drawbacks.

According to one embodiment, a natural language image searching method is applied to an image searching system including an image analysis unit, a data management unit and an instruction input unit. The data management unit is connected to the image analysis unit and the instruction input unit. The natural language image searching method includes an image feature vector encoder of the image analysis unit receiving an image sequence, and utilizing a detection image of the image sequence to generate an image feature vector, the image analysis unit transmitting the detection image, the image feature vector, and a time stamp associated with the detection image, and/or related information to the data management unit, a text encoder of the instruction input unit generating a text feature vector in accordance with a query statement and transmitting the text feature vector to the data management unit, and the data management unit determining whether the query statement generated by the instruction input unit via natural language conforms to the detection image in accordance with a comparison result between the text feature vector and the image feature vector.

According to another embodiment, the operation processor further performs machine learning training based on a plurality of images and related description statement to generate a learning outcome, and the text encoder generates the text feature vector in accordance with the query statement and the learning outcome.

According to another embodiment, an image searching system includes an image analysis unit, a data management unit and an instruction input unit. The image analysis unit includes an image feature vector encoder adapted to receive an image sequence, and utilize a detection image of the image sequence to generate an image feature vector. The image analysis unit transmits the detection image, the image feature vector, and a time stamp associated with the detection image, and/or related information to the data management unit. The instruction input unit includes a text encoder adapted to generate a text feature vector in accordance with a query statement and transmit the text feature vector to the data management unit. The data management unit determines whether the query statement generated by the instruction input unit via natural language conforms to the detection image in accordance with a comparison result between the text feature vector and the image feature vector.

The natural language image searching method and the image searching system of the present invention can perform fast image search by the query statement written in the natural language. The natural language image searching method can search the database of the image searching system, to find out the detection image with the most similar image feature vector and the related time stamp and/or the geographical location and the related information as well as the previous image and the follow-up image within the time period, in accordance with the received text feature vector and the computer format (Structured query) message, and then transmit found data to the client device such as the display screen. That is to say, the natural language image searching method and the image searching system of the present invention can analyze the query statement written in the natural language to generate the text feature vector and the computer format message, which can be compared with an abstract feature (e.g., the image feature vector) analyzed from the detection image; there is no need to restrict the user to use the query statement written in a specific format and standard for image search, so the present invention can provide the preferred user experience. The natural language image searching method and the image searching system of the present invention can enable the image search result to no longer be limited to a scope of conventional query statement, and can effectively improve a breadth of the image search result. The present invention can perform the machine learning training on the description statement written in the natural language, so as to adjust the search condition based on the learning outcome, thereby achieving an effect of significantly improving the accuracy and speed of the image search.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image searching system according to an embodiment of the present invention.

FIG. 2 is a flow chart of the natural language image searching method according to the embodiment of the present invention.

### DETAILED DESCRIPTION

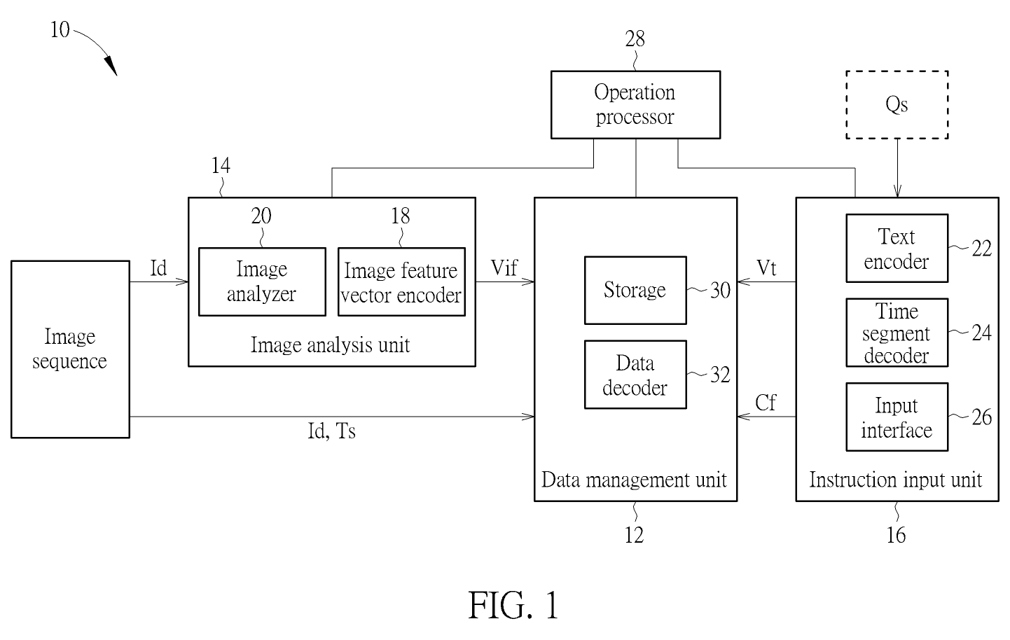

Please refer to FIG. 1. FIG. 1 is a functional block diagram of an image searching system 10 according to an embodiment of the present invention. The image searching system 10 can include a data management unit 12, an image analysis unit 14 and an instruction input unit 16 connected with each other. The image analysis unit 14 can be defined as a device terminal, and used to capture an image sequence (e.g., video data) or to receive the image sequence (e.g., the video data) captured by an external apparatus in a wired manner or in a wireless manner. The instruction input unit 16 can be defined as an operation terminal. The user can input a control command via the instruction input unit 16 in accordance with a personal demand, for searching required information from the image sequence acquired by the image analysis unit 14. The data management unit 12 can be set between the image analysis unit 14 and the instruction input unit 16 to cooperate with other units for executing a natural language image searching method of the present invention. It should be mentioned that the data management unit 12, the image analysis unit 14 and the instruction input unit 16 can be integrated into the same device in the image searching system 10, or can be different independent devices; application of these devices can depend on a design demand.

The natural language image searching method of the present invention means that the user does not need to provide a specific command format. As long as the user inputs the control command edited in natural language via the instruction input unit 16, the required image data can be found from the image sequence of the image analysis unit 14. The image analysis unit 14 can include an image feature vector encoder 18 and an image analyzer 20. The image feature vector encoder 18 can receive the image sequence, and analyze each detection image Id of the image sequence to generate an image feature vector Vif. The image analyzer 20 can determine whether the detection image Id conforms to a preset condition; the preset condition can refer to a specific type of an object being contained in the detection image Id, such as a pedestrian, a vehicle, or any moving object, but actual application is not limited thereto. The present invention can perform image analysis (determining whether the detection image Id conforms to the preset condition) on all the detection images Id in the image sequence, or only on a part of the detection images Id, and its variation can depend on the design demand.

The image analyzer 20 can be an optional element, and used to transmit the detection image Id to the image feature vector encoder 18 for encoding and generating the image feature vector Vif when determining the detection image Id conforms to the preset condition, so as to effectively economize computation resources. After the detection image Id transmitted to the image feature vector encoder 18 is successfully encoded and the image feature vector Vif is generated, it can be searched and found in accordance with a query statement Qs provided by the instruction input unit 16. The detection image Id that has not been encoded can be discarded or retained; moreover, the foresaid detection image Id is not found by the query statement Qs because the foresaid detection image Id does not have the image feature vector Vif.

The instruction input unit 16 can include a text encoder 22, a time segment decoder 24 and an input interface 26. The user can input the query statement Qs edited or written in the natural language via the input interface 26. The text encoder 22 can generate a text feature vector Vt based on the query statement Qs. In the present invention, the query statement Qs can be used to describe the detection image Id; the text encoder 22 can convert specific words in the query statement Qs, such as the type, color, or behavior of an object, or a description of a time range, into a computer format message Cf that can be analyzed by the data management unit 12. The operation processor 28 can be a part of the data management unit 12, the image analysis unit 14, and/or the instruction input unit 16, or can be independent of the data management unit 12, the image analysis unit 14 and the instruction input unit 16. The data management unit 12 can include a storage 30 used to store information of the image analysis unit 14 and the instruction input unit 16. The operation processor 28 can execute the natural language image searching method of the present invention in accordance with information of the data management unit 12, the image analysis unit 14 and the instruction input unit 16, and can be used to continuously perform data storage and encoding and decoding operations when the natural language image searching method analyzes the image. In another possible embodiment, the instruction input unit 16 can further include another information encoder (which is not shown in the figures), such as, but not limited to, a geographic information encoder. Any information that can be used for image content analysis can be a type of the foresaid information encoder of the present invention, and can be applied for the instruction input unit 16 of the present invention.

It should be mentioned that the image feature vector Vif and the text feature vector Vt can be compared by using the K Nearest Neighbor (KNN) algorithm, or any other algorithm with similar functions. Application of the algorithm is not the main technical content of the present invention and is not described herein for simplicity.

For example, if the query statement Qs is “the pedestrian dressed in red clothing that appears every Monday morning between January 1, 2019 and February 5, 2019”, the text encoder 22 can convert the pedestrian dressed in the red clothing into the corresponding text feature vector Vt. The computer format message Cf of starting time can be rewritten by the time segment decoder 24 into a computer-readable format "20190101000000", and the computer format message Cf of ending time can be further rewritten into the computer-readable format "201902050000"; foresaid numbers can represent the year, month, day, hour, minute, and second in sequence. The computer format message Cf of the schedule can be rewritten into "00 6-12 * * 1"; those numbers can represent the seconds, minutes, hours, day, month, and day of the week in sequence, which means every Monday from 6:00 a.m. to 12:00 p.m. regardless of the month or day. The query statement Qs can be generated by using the above-mentioned syntax parsing, and its variation can depend on the design demand and cannot be limited to the foresaid embodiment.

In other possible embodiment, the text feature vector Vt and the corresponding image feature vector Vif can be acquired via neural network training. The data management unit 12 can further perform machine learning training on a plurality of images (which is not shown in the figure) and related description statements in the image sequence, and then set a relevant training model based on a learning outcome of the machine learning training. When the training model reaches a preset level of completion, the text encoder 22 of the instruction input unit 16 can generate the text feature vector Vt in accordance with the query statement Qs and the training model of the learning outcome.

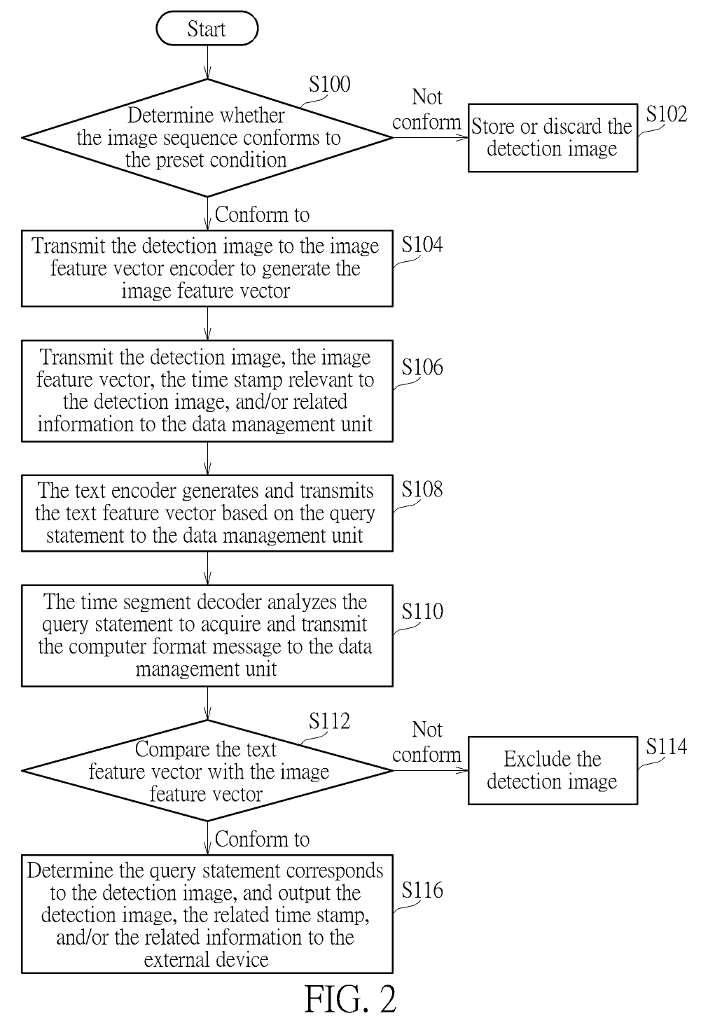

Please refer to FIG. 2. FIG. 2 is a flow chart of the natural language image searching method according to the embodiment of the present invention. The natural language image searching method illustrated in FIG. 2 can be suitable for the image searching system 10 shown in FIG. 1. First, step S100 can be optionally executed that the image analyzer 20 can determine whether the detection image Id of the image sequence (e.g., the video data) conforms to the preset condition. When the detection image Id does not conform to the preset condition, the detection image Id does not contain the specific type of the object, and step S102 can be executed that the image analyzer 20 can transmit the detection image Id to the data management unit 12 to be stored in the storage 30 or directly discarded. When the detection image Id conforms to the preset condition, the detection image Id contains the specific type of object, and step S104 and step S106 can be executed that the image analyzer 20 can transmit the detection image that conforms to the preset condition to the image feature vector encoder 18 so that the image feature vector encoder 18 can generate the image feature vector Vif based on the detection image Id, and then transmit the detection image Id, the image feature vector Vif, a time stamp Ts relevant to the detection image Id, and/or related information (e.g., geographical location) to the data management unit 12.

Then, step S108 and step S110 can be executed that the text encoder 22 of the instruction input unit 16 can generate the text feature vector Vt in accordance with the query statement Qs provided by the input interface 26 and transmit the text feature vector Vt to the data management unit 12, and the time segment decoder 24 of the instruction input unit 16 can analyze the query statement Qs to acquire and transmit the computer format message Cf to the data management unit 12. After that, step S112 can be executed that the data management unit 12 can compare the text feature vector Vt with the image feature vector Vif. When the text feature vector Vt does not conform to the image feature vector Vif, it means that the detection image Id is not a query target of the query statement Qs, and step S114 can be executed to exclude the detection image Id. When the text feature vector Vt conforms to the image feature vector Vif, step S116 can be executed that the data management unit 12 can determine the query statement Qs written in the natural language corresponds to the detection image Id, and output the detection image Id, the related time stamp Ts, and/or the related information (e.g., being relevant to the time stamp Ts and/or the related information of the detection image Id) to an external device such as a display screen for the user to view.

In the present invention, step S116 can transmit the detection image Id that conforms to the query statement Qs, the time stamp Ts relevant to the detection image Id, and/or the related information to the display screen (which is not marked in the figure). As the embodiment mentioned above, the user can see the pedestrian dressed in the red clothing and the specific time and location of his appearance (i.e., the time stamp Ts and/or the related information such as the geographic location) on the display screen. Generally, the specific type of the object does not suddenly appear within a field of view of the image sequence. The image sequence can be video data composed of a series of continuous images, which have a previous image (not marked in the figure) that is earlier than the detection image Id and a follow-up image (not marked in the figure) that is later than the detection image Id. Therefore, the natural language image searching method of the present invention can further optionally transmit the previous image and the follow-up image related to the detection image Id to the display screen by the image analysis unit 14 when executing step S116, so that the display screen can play a short video about the specific type of the object.

In the preferred embodiment of the present invention, the data management unit 12 can optionally include a data decoder 32. In step S100, the data management unit 12 can store metadata of the detection image Id that conforms to the preset condition into the storage 30. The data management unit 12 can further utilize the data decoder 32 to analyze the query statement Qs for generating a keyword. For example, the query statement Qs written in the natural language may be “the pedestrian dressed in the red clothing appeared every Monday morning between January 1, 2019 and February 5, 2019”, and the data decoder 32 can analyze the keyword “the red clothing” and “the pedestrian”, and the detection image Id with the keyword can be found from the metadata in the storage 30 for classification. The detection image Id that is classified as having no keyword can be discarded and no operation is performed. The detection image Id that is classified as having the keyword can be applied for other steps of the natural language image searching method, thereby simplifying a total amount of computation and effectively improving computation efficiency and an accuracy.

In the preferred embodiment of the present invention, when the data management unit 12 acquires the detection image Id based on the foresaid natural language image searching method, the image content of the detection image Id can be automatically analyzed in accordance with the metadata of the detection image Id, and extra analysis of the image content can be performed on the detection image Id in addition to search conditions set by the query statement Qs. Results of the extra analysis can be provided to the user for reference, thereby allowing the user to find the desired image more quickly.

In conclusion, the natural language image searching method and the image searching system of the present invention can perform fast image search by the query statement written in the natural language. The natural language image searching method can search the database of the image searching system, to find out the detection image with the most similar image feature vector and the related time stamp and/or the geographical location and the related information as well as the previous image and the follow-up image within the time period, in accordance with the received text feature vector and the computer format message, and then transmit found data to the client device such as the display screen. That is to say, the natural language image searching method and the image searching system of the present invention can analyze the query statement written in the natural language to generate the text feature vector and the computer format message, which can be compared with an abstract feature (e.g., the image feature vector) analyzed from the detection image; there is no need to restrict the user to use the query statement written in a specific format and standard for image search, so the present invention can provide the preferred user experience.

The natural language image searching method and the image searching system of the present invention can enable the image search result to no longer be limited to a scope of conventional query statement, and can effectively improve a breadth of the image search result; for example, the conventional query statement must preset a search item and a content option, and the user only selects the search condition that meets the foresaid content option, which not only limits the freedom of search, but also limits the breadth of search result. The present invention can perform the machine learning training on the description statement written in the natural language, so as to adjust the search condition based on the learning outcome, thereby achieving an effect of significantly improving the accuracy and speed of the image search.

Those skilled in the art will readily observe that numerous modifications and alterations of the unit and method may be made while retaining the teachings of the invention. Accordingly, the above disclosure should be construed as limited only by the metes and bounds of the appended claims.

What is claimed is:

1. A natural language image searching method applied to an image searching system including an image analysis unit, a data management unit and an instruction input unit, the data management unit being connected to the image analysis unit and the instruction input unit, the natural language image searching method comprising:
an image feature vector encoder of the image analysis unit receiving an image sequence, and utilizing a detection image of the image sequence to generate an image feature vector;
the image analysis unit transmitting the detection image, the image feature vector, a time stamp associated with the detection image, and/or related information to the data management unit;
a text encoder of the instruction input unit generating a text feature vector in accordance with a query statement and transmitting the text feature vector to the data management unit; and
the data management unit determining whether the query statement written in natural language and generated by the instruction input unit conforms to the detection image in accordance with a comparison result between the text feature vector and the image feature vector.

2. The natural language image searching method of claim 1, wherein the image sequence comprises a previous image earlier than the detection image and a follow-up image later than the detection image, the natural language image searching method further comprises:
the image analysis unit transmitting the previous image and the follow-up image to the data management unit.

3. The natural language image searching method of claim 2, further comprising:
the data management unit outputting the detection image, the time stamp associated with the detection image, and/or the related information of the previous image and the follow-up image when the query statement conforms to the detection image.

4. The natural language image searching method of claim 1, further comprising:
an image analyzer of the image analysis unit determining whether the detection image conforms to a preset condition;
the image analyzer transmitting the detection image that conforms to the preset condition to the image feature vector encoder; and
the image feature vector encoder generating the image feature vector in accordance with the detection image.

5. The natural language image searching method of claim 4, wherein the preset condition refers to the detection image containing a specific type of an object.

6. The natural language image searching method of claim 1, further comprising:
a time segment decoder of the instruction input unit analyzing the query statement to acquire a computer format message, and transmitting the computer format message to the data management unit.

7. The natural language image searching method of claim 1, further comprising:
a ddata decoder of the data management unit analyzing the query statement to acquire a keyword; and
an operation processor of the data management unit utilizing the keyword to classify the detection image that conforms to the preset condition.

8. The natural language image searching method of claim 7, wherein the operation processor stores metadata of the detection image that conforms to t the preset condition in storage of the data management unit.

9. The natural language image searching method of claim 7, wherein the operation processor further performs machine learning training based on a plurality of images and related description statement to generate a learning outcome, and the text encoder generates the text feature vector in accordance with the query statement and the learning outcome.

10. An image searching system comprising:
an image analysis unit, comprising an image feature vector encoder adapted to receive an image sequence, and utilize a detection image of the image sequence to generate an image feature vector;
a data management unit, wherein the image analysis unit transmits the detection image, the image feature vector, a time stamp associated with the detection image, and/or related information to the data management unit; and
an instruction input unit, comprising a text encoder adapted to generate a text feature vector in accordance with a query statement and transmit the text feature vector to the data management unit;
wherein the data management unit determines whether the query statement written in natural language and generated by the instruction input unit conforms to the detection image in accordance with a comparison result between the text feature vector and the image feature vector.

11. The image searching system of claim 10, wherein the image sequence comprises a previous image earlier than the detection image and a follow-up image later than the detection image, the image analysis unit is adapted to further transmit the previous image and the follow-up image to the data management unit.

12. The image searching system of claim 11, wherein the data management unit is adapted to further output the detection image, the time stamp associated with the detection image, and/or the related information of the previous image and the follow-up image when the query statement conforms to the detection image.

13. The image searching system of claim 10, wherein an image analyzer of the image analysis unit is adapted to determine whether the detection image conforms to a preset condition, and transmit the detection image that conforms to the preset condition to the image feature vector encoder; and the image feature vector encoder is adapted to further generate the image feature vector in accordance with the detection image.

14. The image searching system of claim 13, wherein the preset condition refers to the detection image containing a specific type of an object.

15. The image searching system of claim 10, wherein a time segment decoder of the instruction input unit is adapted to analyze the query statement to acquire a computer format message, and transmit the computer format message to the data management unit.

16. The image searching system of claim 10, wherein a data decoder of the data management unit is adapted to analyze the query statement to acquire a keyword, and an operation processor of the data management unit is adapted to utilize the keyword to classify the detectionn image that conforms to the preset condition.

17. The image searching system of claim 16, wherein the operation processor is adapted to further store metadata of the detection image that conforms to t the preset condition in storage of the data management unit.

18. The image searching system of claim 16, wherein the operation processor is adapted to further perform machine learning training based on a plurality of images and related description statement to generate a learning outcome, and the text encoder is adapted to further generate the text feature vector in accordance with the query statement and the learning outcome.
